(19) United States
(12) Patent Application Publication
(10) Pub. No.: US 2016/0048422 A1
(43) Pub. Date: Feb. 18, 2016

(54) ERROR DETECTION DEVICE AND ERROR DETECTION METHOD

(71) Applicant: FUJITSU LIMITED, Kawasaki-shi (JP)

(72) Inventor: Masayuki Tanaka, Ashikaga (JP)

(21) Appl. No.: 14/726,832

(22) Filed: Jun. 1, 2015

(30) Foreign Application Priority Data
Aug. 13, 2014 (JP) 2014-165004

(51) Int. Cl. G06F 11/10

(52) U.S. Cl. CPC G06F 11/1004; G06F 11/1076

(57) ABSTRACT

An error detection device includes: a writing portion configured to write, in an address of the storage, first data including a first error determination code in which a different error detection rule is applied in association with the address; a reading portion configured to read the first data from the storage as second data; and a detector configures to detect an error, using a second error determination code of the second data.

### CROSS-REFERENCE TO RELATED APPLICATION

This application is based upon and claims the benefit of priority of the prior Japanese Patent Application No. 2014-165004, filed on Aug. 13, 2014, the entire contents of which are incorporated herein by reference.

### FIELD

The embodiments discussed herein are related to an error detection device and an error detection method.

### BACKGROUND

In an error detection device that performs reception and transmission of data such as a packet, a memory is used at the time of conversion of a clock from a reference clock to an individual clock, scheduling, and path determination.

The related arts have been discussed in Japanese Laid-open Patent Publication No. 6-202963, Japanese Laid-open Patent Publication No. 10-135961, and Japanese Laid-open Patent Publication No. 5-265868.

### SUMMARY

According to an aspect of the embodiments, an error detection device includes: a writing portion configured to write, in an address of the storage, first data including a first error determination code in which a different error detection rule is applied in association with the address; a reading portion configured to read the first data from the storage as second data; and a detector configures to detect an error, using a second error determination code of the second data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a communication device;

FIG. 2 illustrates an example of an error detection device;

FIGS. 3A and 3B illustrate an example of a normal operation;

FIGS. 4A and 4B illustrate an example of an operation at a time of occurrence of a read failure;

FIGS. 5A and 5B illustrate an example of an operation at a time of occurrence of a read failure from a certain address;

FIG. 6 illustrates an example of an error detection device;

FIG. 7 illustrates an example of an error detection device;

FIG. 8 illustrates an example of an error detection device;

FIG. 9 illustrates an example of an error detection device;

FIG. 10 illustrates an example of an error detection device;

FIG. 11 illustrates an example of an error detection device; and

FIG. 12 illustrates an example of an error detection device.

### DESCRIPTION OF EMBODIMENTS

When the error detection device uses a memory, an error determination code such as parity is assigned to data in order to check whether or not data writing to the memory and data reading from the memory are performed correctly.

The error detection device includes two ports for writing and reading when First In First Out (FIFO) is used as a memory. At the time of data writing, the error detection device generates an error determination code with reference to the value of the write data, and writes the write data and the error determination code to an identical address. At the time of data reading, the error detection device generates an error determination code with reference to the value of the read data, and then compares the error determination code with the error determination code that has been generated at the time of data writing. The error detection device determines whether or not there is an error in the data that has been read from the memory, and detects the determination as an error when there is an error.

In a case in which it is assumed that writing to the memory and reading from the memory are allowed to be performed, when a memory failure occurs in which writing or reading of data is not performed during communication, error determination for the data may not be performed correctly. For example, writing may not be performed due to damage of a write circuit. Data that has been previously written, to which the error determination code has been assigned appropriately, is read from the memory, so that an error may not be detected. For example, reading may not be performed due to damage of a read circuit. Data of another address, which has just been read, and to which the error determination code has been assigned appropriately, is a target of the error determination, so that an error may not be detected.

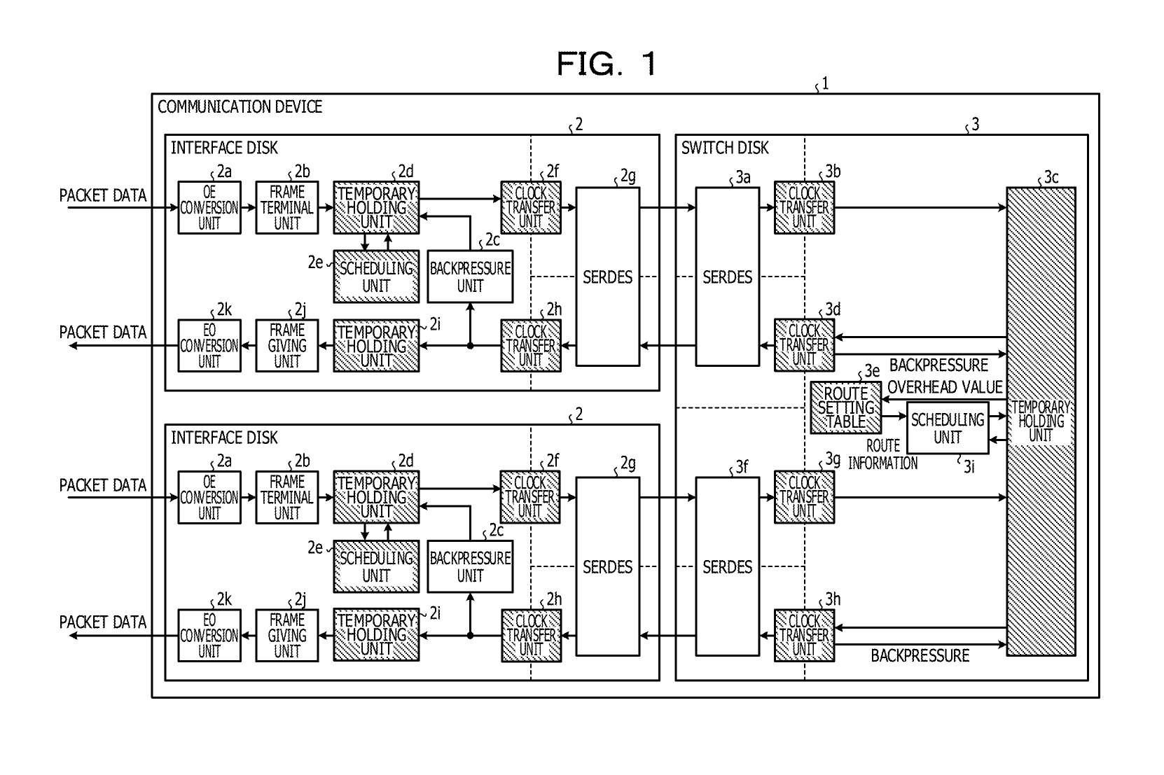

FIG. 1 is an example of a communication device. A communication device 1 illustrated in FIG. 1 includes an interface panel 2 and a switch panel 3. The configuration elements are coupled to each other so that input and output of a signal and data are allowed to be performed in one direction or bidirectionally.

The interface panel 2 includes an optical-to-electrical (OE) conversion unit 2a, a frame terminal unit 2b, a backpressure unit 2c, a temporary holding unit 2d, a scheduling unit 2e, a clock changing unit 2f, a serializer/deserializer (SERDES) 2g, a clock changing unit 2h, a temporary holding unit 2i, a frame giving unit 2j, and an electrical-to-optical (EO) conversion unit 2k. These configuration elements are coupled to each other so that input and output of a signal and data are allowed to be performed in one direction or bidirectionally.

In the interface panel 2, received packet data is converted into an electric signal by the OE conversion unit 2a, and terminated by the frame terminal unit 2b. When band control information is notified from the backpressure unit 2c, the packet data that has been output from the frame terminal unit 2b is held in the temporary holding unit 2d, and input to the clock changing unit 2f in accordance with a scheduling result by the scheduling unit 2e. In the scheduling, for example, priority determination of the packet data is performed based on information of the overhead (OH) and the previous output status. The clock changing unit 2f changes the operation clock from the clock that has been extracted from the input data, into a clock that has been generated on the communication device 1 side, for example, an internal clock. After that, the packet data is transferred to the switch panel 3 at high speed by the SERDES 2g.

Data input to the interface panel 2 is not limited to the packet data, and may be frame data of an optical transport network (OTN), a synchronous optical network (SONET), or the like.

At the time of transmission of packet data, the interface panel 2 executes a similar processing in the reverse order of the time of reception of the packet data. For example, packet data that has been output from the SERDES 2g is temporarily held in the temporary holding unit 2i after clock changing by the clock changing unit 2h. After that, the OH and the like are assigned to the packet data by the frame giving unit 2j, and the packet data is converted into an optical signal by the EO conversion unit 2k, and transmitted to an external device.

The switch panel 3 includes a SERDES 3a, a clock changing unit 3b, a temporary holding unit 3c, a clock changing unit 3d, a route setting table 3e, a SERDES 3f, a clock changing unit 3g, and a clock changing unit 3h. The configuration elements may be coupled to each other so that input and output of a signal and data are allowed to be performed in one direction or bidirectionally.

In the switch panel 3, a route of the packet data that has been transferred from the interface panel 2 at high speed is switched, and the packet data is transmitted to the external device through another interface panel 2. In the switch panel 3, when the packet data is received by the SERDES 3a, clock changing into a reference clock is performed by the clock changing unit 3b. After the packet data has been temporarily held in the temporary holding unit 3c, the packet data is input to the clock changing unit 3d or the clock changing unit 3h in accordance with a scheduling result of a scheduling unit 3i. The clock changing units 3d and 3h respectively change the clocks from the reference clocks to the transmission clocks of the SERDESs 3a and 3f. On the contrary, at the time of transmission, in the switch panel 3, clock changing is performed by the clock changing unit 3d. The switch panel 3 refers to the route setting table 3e, and obtains information on a route (output destination) that corresponds to the OH value of the packet data. The scheduling unit 3i performs scheduling, based on the route information that has been obtained from the route setting table 3e, for each output destination.

The SERDES 3f and the clock changing units 3g and 3h of the switch panel 3 may respectively have configurations that are substantially the same as or similar to the configurations of the SERDES 3a and the clock changing units 3b and 3d, and the detailed descriptions may be omitted.

For each of the pieces of processing in the shaded blocks in FIG. 1, a memory may be used. For example, for the each of the temporary holding units 2d, 2i, and 3c, and the clock changing units 2f, 2h, 3b, 3d, 3g, and 3h, a memory is used in order to store packet data. For the scheduling unit 2e, a memory is used in order to store information that indicates a storage destination of a packet temporarily held. For the route setting table 3e, a memory is used in order to store a large volume of route information.

Densification of the communication device 1 may increase an impact on another configuration element due to a hardware failure of a memory or the like. When damage of a write circuit or a read circuit that is included in the memory occurs, the communication device 1 becomes in an abnormal state without raising an alarm, so that a large amount of time and money may be used to investigate the cause. In the communication device, an error, for example, an error in which writing or reading for the memory is not performed correctly may be detected accurately and quickly by the error detection device.

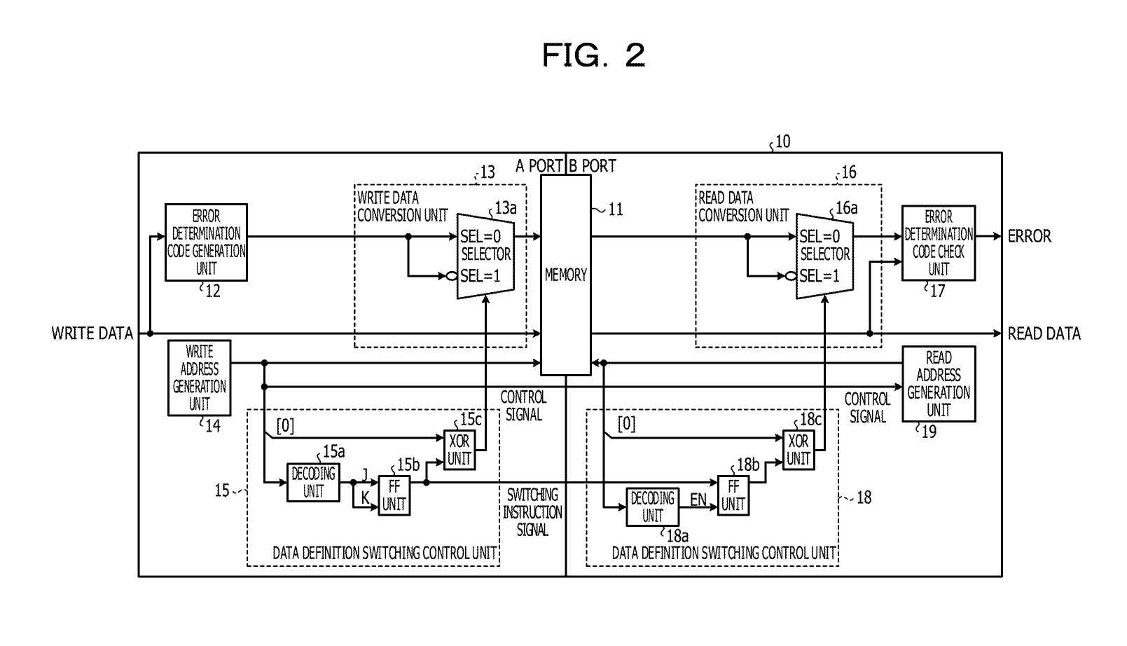

FIG. 2 illustrates an example of an error detection device. An error detection device 10 illustrated in FIG. 2 includes a memory 11 that holds data, for example, packet data, an A port for data writing, and a B port for data reading. The error detection device 10 includes, on the A port side, an error determination code generation unit 12, a write data conversion unit 13, a write address generation unit 14, and a data definition switching control unit 15. The error detection device 10 includes, on the B port side, a read data conversion unit 16, an error determination code check unit 17, a data definition switching control unit 18, and a read address generation unit 19. The configuration elements may be coupled to each other so that input and output of a signal and data are allowed to be performed in one direction or bidirectionally.

The memory 11 temporarily holds data that has been input from the write data conversion unit 13, and outputs the data to the read data conversion unit 16. The error determination code generation unit 12 generates an error determination code, from input write data. The write data conversion unit 13 includes a selector 13a, and switches definition of parity, for example, an error detection rule, in accordance with a control signal from the data definition switching control unit 15. For example, in a case in which the control signal is “0”, the write data conversion unit 13 sets odd number parity as the parity definition when a write destination address is an even number address, and sets even number parity as the parity definition when the write destination address is an odd number address. In a case in which the control signal is “1”, the write data conversion unit 13 sets even number parity as the parity definition when the write destination address is an even number address, and sets odd number parity as the parity definition when the write destination address is an odd number address.

The write address generation unit 14 generates an address in the memory 11, which is a write destination of data. The data definition switching control unit 15 inverts a switching instruction signal when the write address value reaches a full count value. The write address generation unit 14 outputs exclusive OR between the inverted switching instruction signal and the least significant bit (LSB) of the write address, to the write data conversion unit 13, as the control signal. The data definition switching control unit 15 controls the control signal to be switched for each write address.

The data definition switching control unit 15 includes a decoding unit 15a, a flip-flop (FF) unit 15b, and an XOR unit 15c. The decoding unit 15a detects that the write address that has been generated by the write address generation unit 14 becomes the maximum value. Each time the decoding unit 15a detects the maximum value, the FF unit 15b changes the value from “0” to “1” or changes the value from “1” to “0”, and maintains the changed state. The XOR unit 15c may be an exclusive OR circuit. The XOR unit 15c performs output of “0” when the lowest address value of the write address and the output value from the FF unit 15b, for example, “0” or “1” are matched with each other, and the XOR unit 15c performs output of “1” when the values are not matched with each other. In the lowest address value of the write address, “0” may indicate an even number address, and “1” may indicate an odd number address.

The read data conversion unit 16 includes a selector 16a, and switches definition of parity in accordance with a control signal from the data definition switching control unit 18. For example, in a case in which the control signal is “0”, the read data conversion unit 16 sets odd number parity as the parity definition when a read source address is an even number address, and sets even number parity as the parity definition when the read source address is an odd number address. In a case in which the control signal is “1”, the read data conversion unit 16 sets even number parity as the parity definition when the read source address is an even number address, and sets odd number parity as the parity definition when the read source address is an odd number address. The error determination code check unit 17 checks whether or not a relationship between the read data and the error determination code is substantially the same as that of the case of writing (performs error determination), and detects an error when the relationships are different from each other.

The data definition switching control unit 18 receives a switching instruction signal output from the FF unit 15b when the read address value reaches a full count value. The data definition switching control unit 18 outputs exclusive OR between the switching instruction signal and the LSB of the read address, to the read data conversion unit 16, as the control signal. The data definition switching control unit 18 controls the control signal to be switched for each read address.

The data definition switching control unit 18 includes a decoding unit 18a, an FF unit 18b, and an XOR unit 18c. The decoding unit 18a detects that the read address that has been generated by the read address generation unit 19 becomes the maximum value. The FF unit 18b receives a switching instruction signal from the data definition switching control unit 15 each time the decoding unit 18a detects the maximum value, and maintains the reception state. The XOR unit 18c may be an exclusive OR circuit. The XOR unit 18c performs output of “0” when the lowest address value of the read address and the output value from the FF unit 18b (the above-described “0” or “1”) are matched with each other, and performs output of “1” when the values are not matched with each other. In the lowest address value of the read address, “0” may indicate an even number address, and “1” may indicate an odd number address.

The read address generation unit 19 generates an address in the memory 11, which is a read source of data.

For example, parity may be applied to the error detection device 10, as an error determination code. For example, a switching condition between odd number parity and even number parity may be one rotation of the addresses. As an attribute of data, an 8 bit width and ALL 0 fixed may be employed, and as addresses, “0” to “7” may be used.

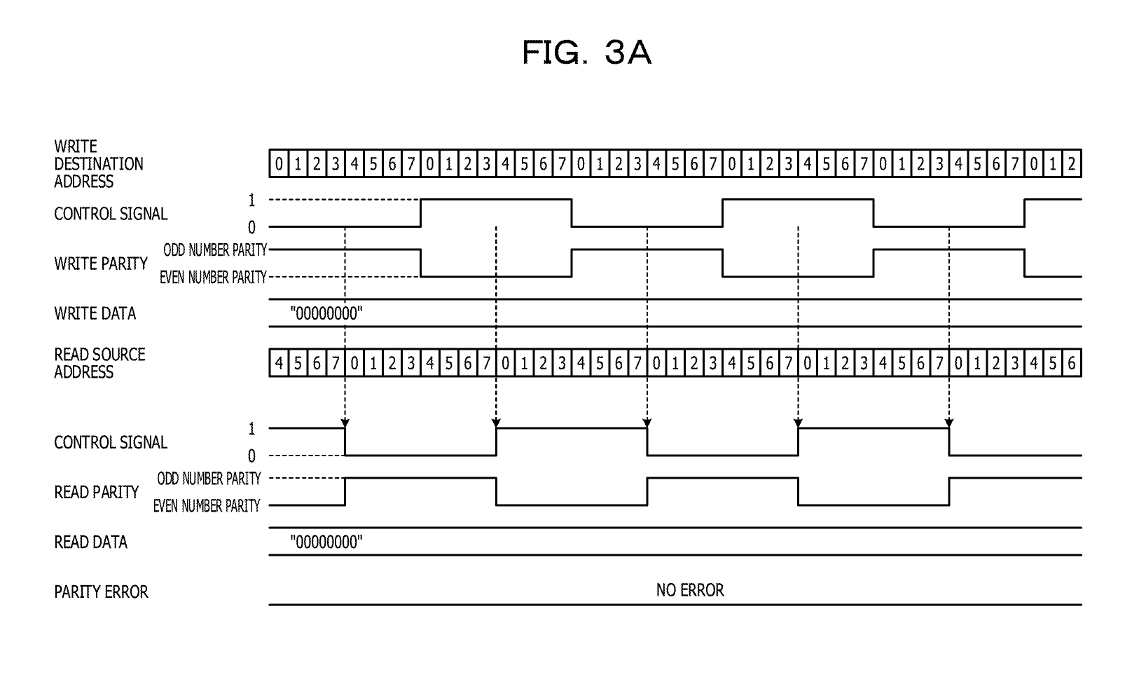

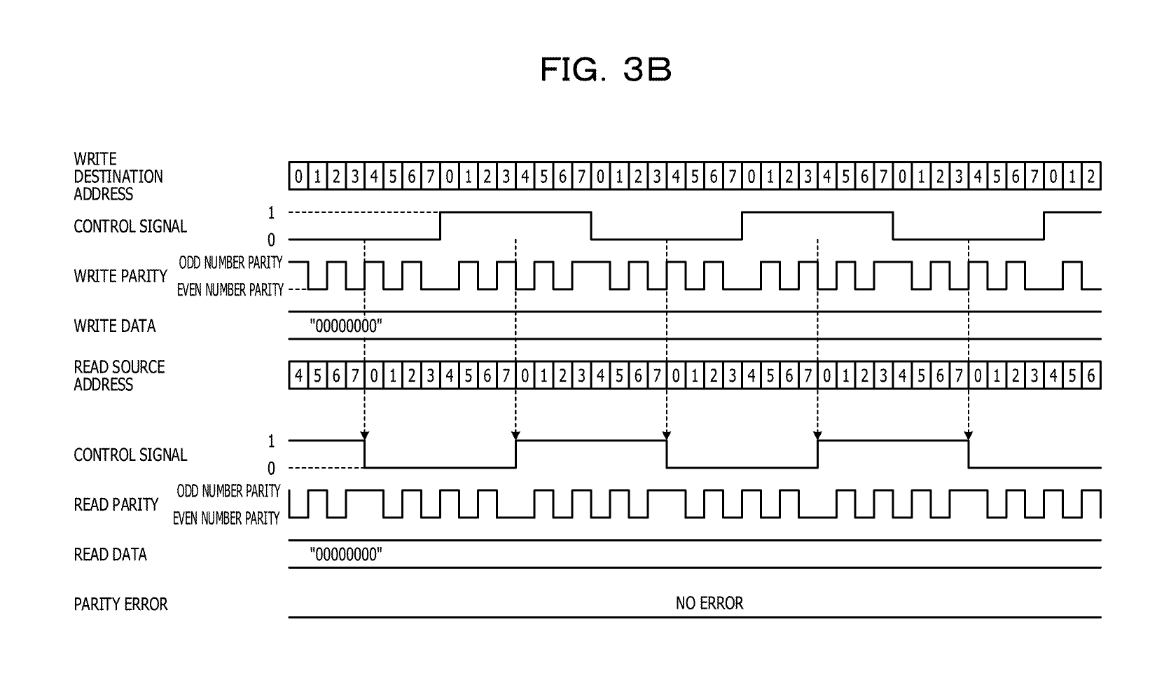

FIGS. 3A and 3B are an example of a normal operation. In FIG. 3A, for example, both write address and read address correspond to 3 bits, and both write data and read data correspond to 8 bits. With one rotation of the write addresses, the write parity is switched from the odd number to the even number or switched from the even number to the odd number, based on the control signal. Similarly, with one rotation of the read addresses, the read parity is switched from the odd number to the even number or switched from the even number to the odd number, based on the control signal. At the time point, an error does not occur, so that the state of “0” is maintained in the parity error.

In FIG. 3B, for example, the value of write parity is set differently value depending on whether the write address is the odd number or the even number. Similarly, the value of read parity is set differently depending on whether the read address is the odd number or the even number. At the time point, an error does not occur yes, so that the state of “0” is maintain in the parity error.

For example, in FIG. 3A, when the control signal is “0”, the parity definition (error detection rule) corresponds to the odd number parity regardless whether the write destination address is the even number address (for example, 0, 2, 4, or 6) or an odd number address (for example, 1, 3, 5, or 7). For example, in FIG. 3B, in a case in which the control signal is “0”, when the write destination address is the even number address, the parity definition corresponds to the odd number parity, and when the write destination address is the odd number address, the parity definition corresponds to the even number parity. In a case in which the control signal is “1”, when the write destination address is the even number address, the parity definition corresponds to the even number parity, and when the write destination address is the odd number address, the parity definition corresponds to the odd number parity. For example, the write parity is defined so that the error detection rule is different depending on a write destination address.

Similarly, in the reading, for example, in FIG. 3A, when the control signal is “0”, the parity definition (error detection rule) corresponds to the odd number parity regardless whether the read source address is the even number address (for example, 0, 2, 4, or 6) or the odd number address (for example, 1, 3, 5, or 7). For example, in FIG. 3B, in a case in which the control signal is “0”, when the read source address is the even number address, the parity definition corresponds to the odd number parity, and when the read source address is the odd number address, the parity definition corresponds to the even number parity. In a case in which the control signal is “1”, when the read source address is the even number address, the parity definition corresponds to the even number parity, and when the read source address is the odd number address, the parity definition corresponds to the odd number parity. For example, the read parity is defined so that the error detection rule is different depending on a read source address.

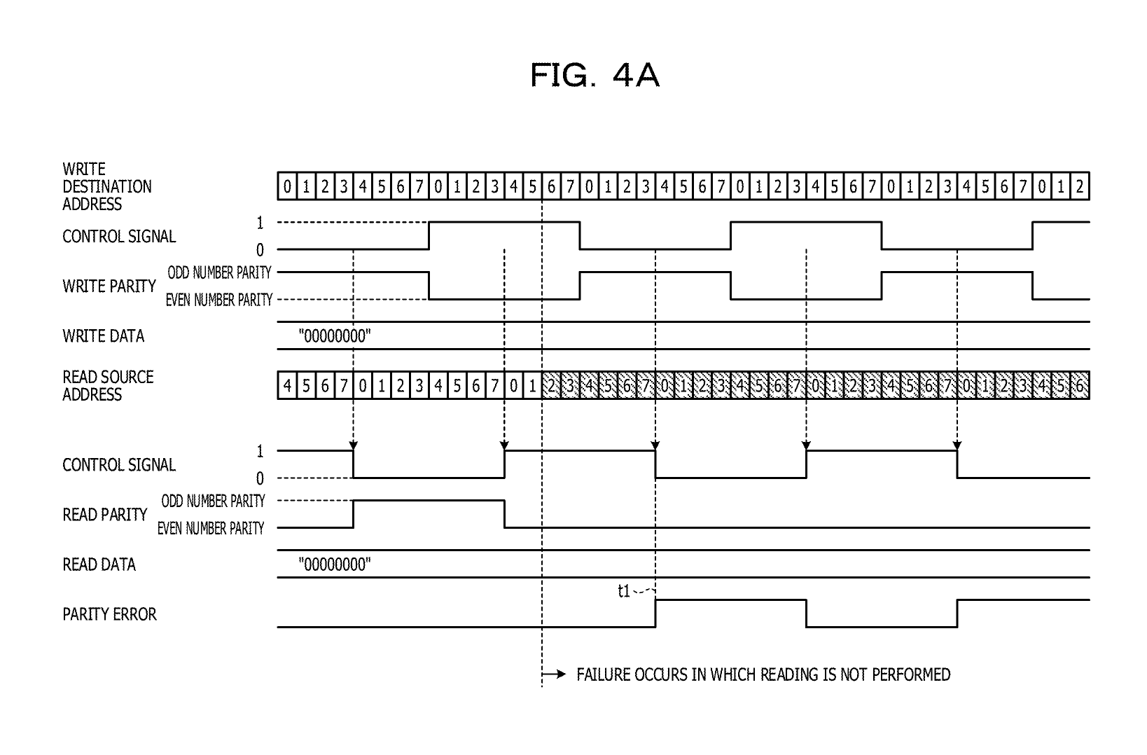

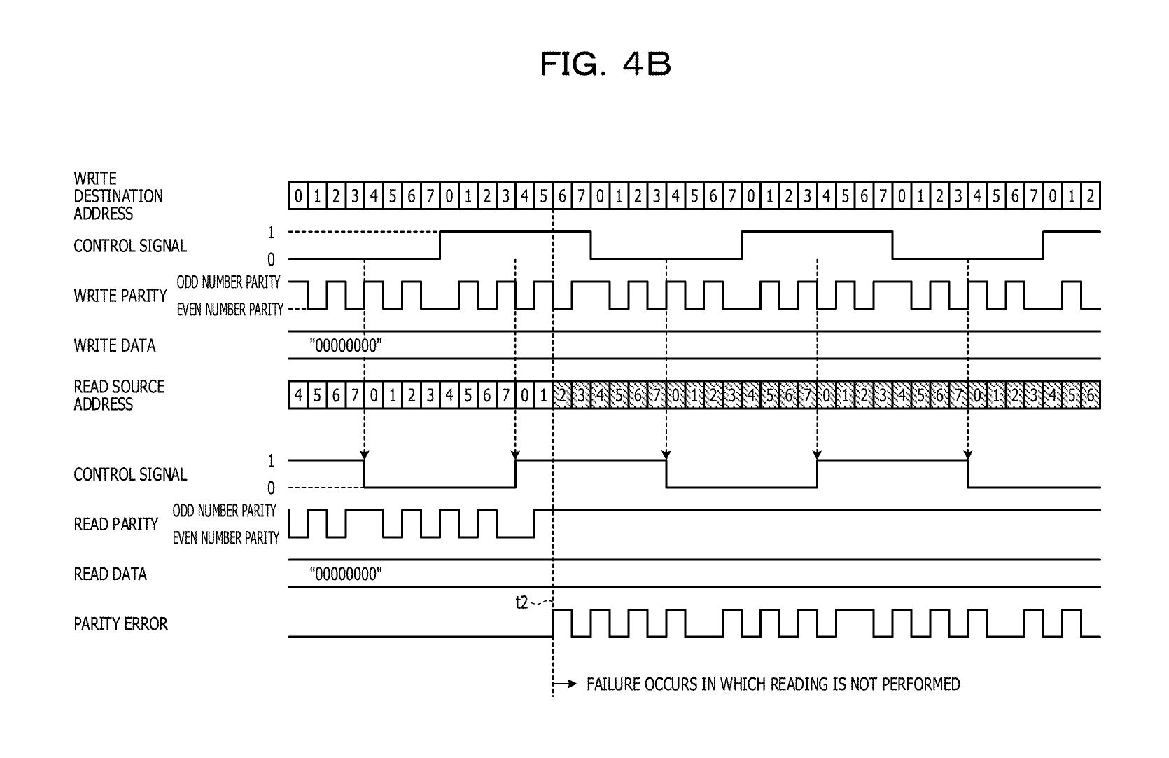

FIGS. 4A and 4B illustrate an example of an operation at the time of occurrence of a read failure. In FIG. 4A, the hatched portion attached to the read addresses indicates that reading is not performed from the read addresses due to damage of a read circuit, or the like. In FIG. 4A, upon that reading of a read address “2” corresponding to the third data fails to be performed, subsequent addresses is not performed, so that, first, the parity error is detected at timing (switching timing) t1 of the leading address “0” of the subsequent pieces of data. For example, in FIG. 4A, even when a failure occurs in which reading is not performed, an error is not detected until the timing t1 at which the control signal is changed from “1” to “0”.

In FIG. 4B, the hatched portion attached to the read addresses indicates that reading is not performed from the read addresses due to damage of a read circuit, or the like. In FIG. 4B, upon that reading of a read address “2” corresponding to the third data fails to be performed, the subsequent addresses is not performed, so that, first, the parity error is detected at timing t2 of the read address “2”. For example, in FIG. 4B, when a failure occurs in which the reading is not performed, an error may be capable of being detected based on the leading address “2” in the addresses in which the reading is not performed.

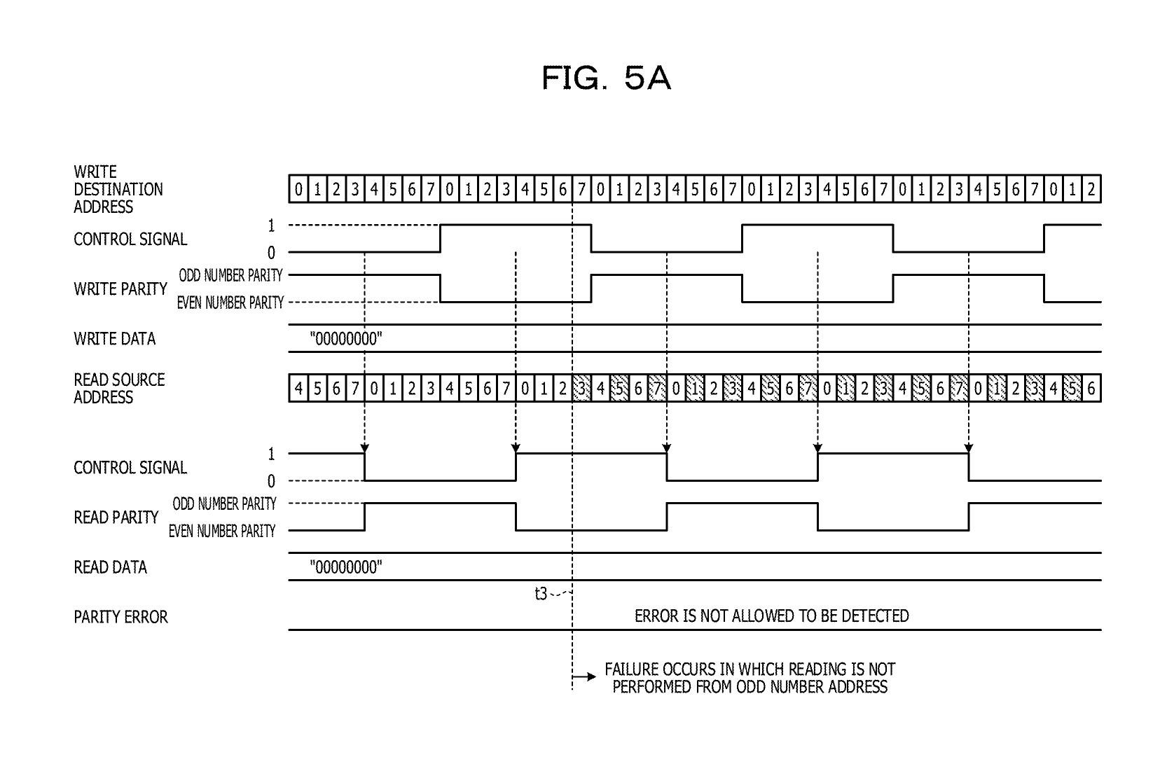

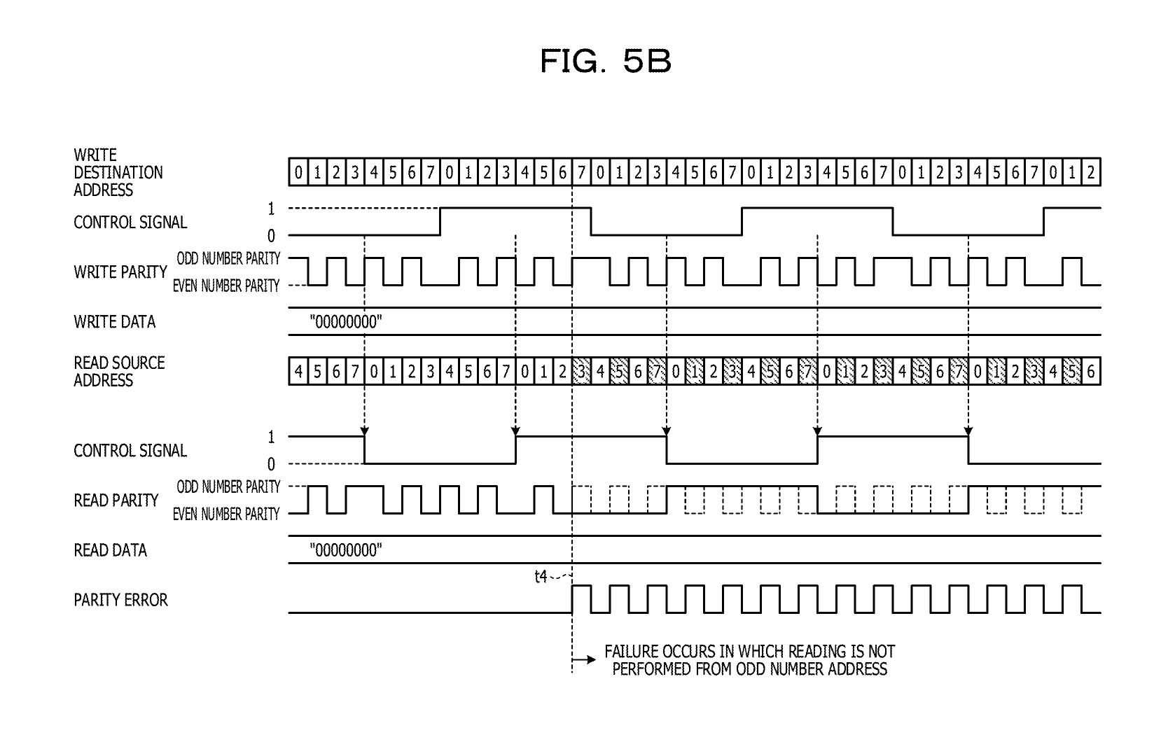

FIGS. 5A and 5B indicate an example of an operation at the time of occurrence of a read failure from certain addresses. The certain addresses may be, for example, odd number addresses. In FIG. 5A, the hatched portion attached to the read addresses indicates reading is not performed from the read addresses due to damage of a read circuit, or the like. In FIG. 5A, upon that reading fails to be performed from odd number addresses from among a read address “3” corresponding to the fourth data and the subsequent addresses, so that the value of the one-previous address, for example, the even number address is viewed from the read data conversion unit 16. Normal reading is allowed to be performed from the one-previous read address “2”, and the read parity that is the same as the read address “3” is assigned to the one-previous read address “2”. Therefore, the error detection device 10 may not detect a parity error when a read failure from a certain address, for example, the odd number address occurs.

In FIG. 5B, the hatched portion attached to the read addresses indicates that reading is not performed from the read addresses due to damage of a read circuit, or the like. In FIG. 5B, upon that reading fails to be performed from the odd number addresses from among the read address “3” corresponding to the fourth data and the subsequent address, so that the value of the one-previous address, for example, the even number address is viewed from the read data conversion unit 16. In FIG. 5B, normal reading is allowed to be performed from the one-previous read address “2”, and read parity that is different from that of the read address “3” is assigned to the one-previous read address “2”. Here, parity in which a different error detection rule is applied depending on an address is assigned to the data. Thus, even when a read failure from a certain address, for example, an odd number address occurs, the error detection device 10 may detect a parity error.

The error detection device 10 includes the write data conversion unit 13, the read data conversion unit 16, and the error determination code check unit 17. The write data conversion unit 13 adds, to data, an error determination code in which a different error detection rule is applied depending on an address in the memory 11, and writes the data onto the address. The read data conversion unit 16 reads the data from the memory 11. The error determination code check unit 17 determines the occurrence of an error in the data, using the error determination code that has been assigned to the data that has been read from the read data conversion unit 16.

The error detection device 10 changes the definition of data, for example, a relationship between the data and an error determination code so as to associate the definition of the data with a memory address. Thus, parity assigned to the data that has been read from the memory 11 changes alternately depending on the definition of the data, for example, from an even number to an odd number, and from the odd number to an even number. Therefore, when a problem occurs in the address control due to a failure of the memory 11, for example, even in a failure in which the previously-read data is read again due to damage of a read circuit, or the like, an error may be detected.

For example, the error determination code check unit 17 compares an error determination code that has been assigned to the data by the write data conversion unit 13, with an error determination code generated from the data that has been read by the read data conversion unit 16 through a certain error detection rule, and determines the occurrence of an error, based on the comparison result. Even when a problem occurs in the address control due to a failure of the memory 11, the error detection device 10 may detect occurrence of an error because an error determination code that has been assigned in advance is not matched with an error determination code that has been generated after the data reading.

For example, the write data conversion unit 13 assigns an odd number parity to data when an address of a write destination of the data is an even number address, and assigns even number parity to the data when the address of the write destination of the data is an odd number address. The error determination code check unit 17 determines the occurrence of an error by applying an error detection rule of the odd number parity to the data of the even number address. The error determination code check unit 17 determines the occurrence of an error by applying an error detection rule of the even number parity to the data of the odd number address. Therefore, for example, when the previously-written data has been read from the memory 11 due to a failure of the memory 11, parity is not assigned to the read data appropriately, for example, the even number and the odd number are reversed, so that an error may be detected. Similarly, due to a failure of the memory 11, for example, when the previously-read data in another address, for example, the immediately-previously-read data is a target of error determination, parity may not be assigned to the data appropriately, for example, the even number and the odd number are reversed, so that an error may be detected.

Even when a problem occurs in the address control due to damage of a write circuit or a read circuit included in the memory, occurrence of an error may be detected accurately and quickly by applying the error detection device 10 to the communication device 1. Therefore, in the communication device 1, an impact on the communication by a memory failure such as interruption or delay, or an impact on another hardware may be reduced, and high-speed communication of a packet or the like may be maintained. The error detection device 10 may be applied to a device that does not have a communication function, for example, an information processing device.

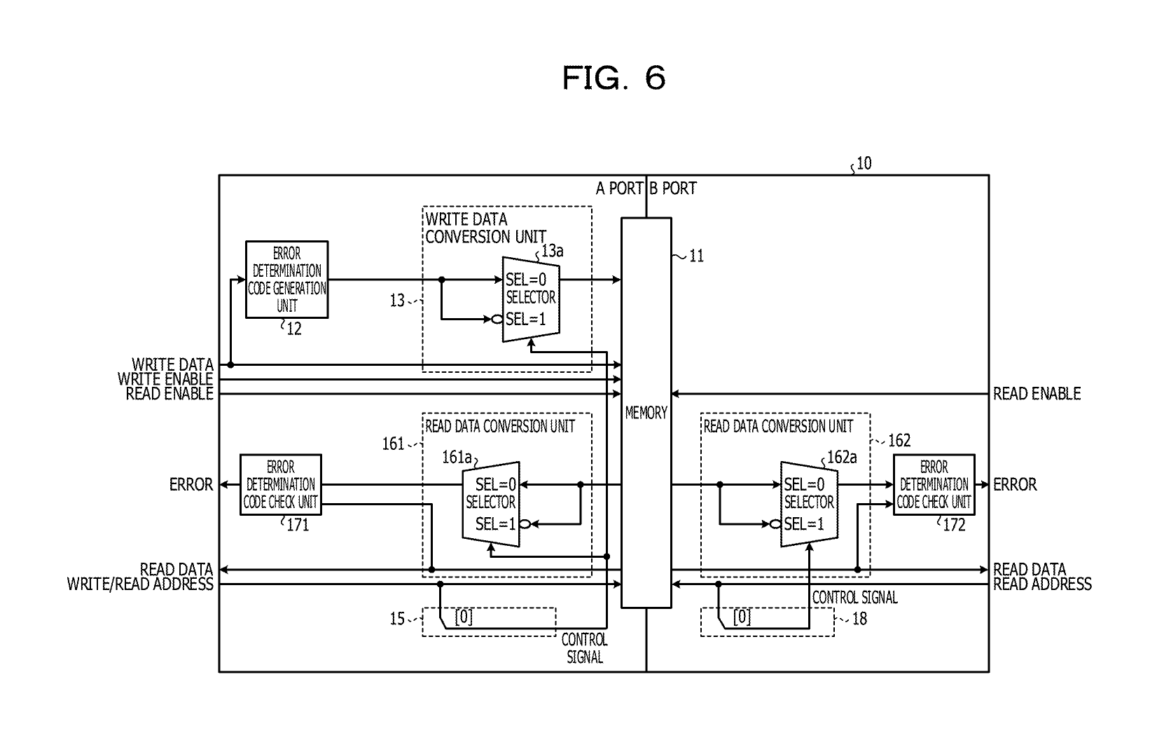

FIG. 6 illustrates an example of an error detection device. In an error detection device illustrated in FIG. 6, the same reference numeral is used for a configuration element that is substantially the same as or similar to that of the error detection device 10 illustrated in FIG. 2, and the detailed description may be omitted or reduced herein. For example, read data conversion units 161 and 162 of the error detection device 10 illustrated in FIG. 6 may correspond to the read data conversion unit 16 illustrated in FIG. 2, and error determination code check units 171 and 172 illustrated in FIG. 6 may correspond to the error determination code check unit 17 illustrated in FIG. 2.

The data definition switching control unit 15 outputs the LSB of the write address, to the read data conversion unit 161, as a control signal. The write data conversion unit 13 switches the definition of parity, to an odd number or an even number, based on the control signal that has been input from the data definition switching control unit 15. For example, the write data conversion unit 13 sets odd number parity as the parity definition when the control signal is “0”, and sets even number parity as the parity definition when the control signal is “1”.

Similarly, the data definition switching control unit 18 outputs the LSB of the read address, to the read data conversion unit 162, as a control signal. The read data conversion unit 162 switches the definition of parity to an odd number or an even number, based on the control signal that has been input from the data definition switching control unit 18. For example, the read data conversion unit 162 sets odd number parity as the parity definition when the control signal is “0”, and sets even number parity as the parity definition when the control signal is “1”.

In the error detection device 10 illustrated in FIG. 6, data writing is performed using software, so that writing may not be performed using something other than software. For example, a failure in which writing is not performed is recognized by reading determination performed at the time of writing, so that measures may not be taken. In the error detection device 10 illustrated in FIG. 6, when the memory 11 is failed due to damage of a circuit, or the like, an error may be detected by another simple configuration.

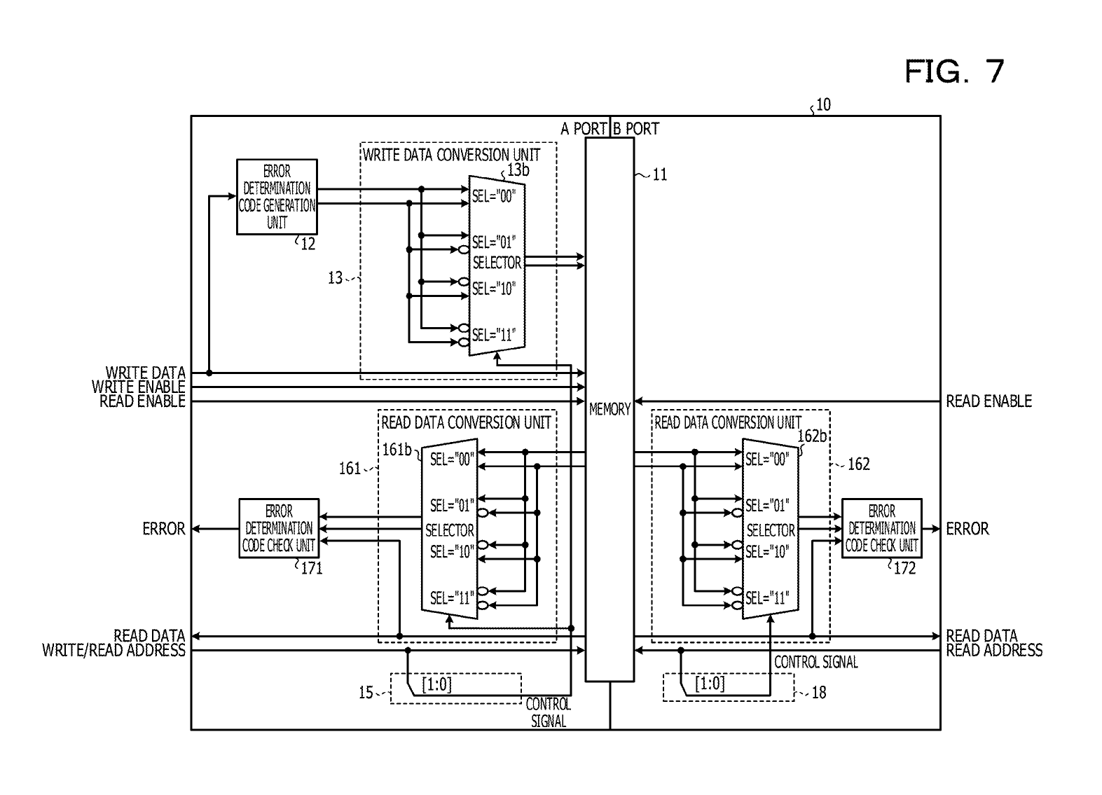

FIG. 7 illustrates an example of an error detection device. As illustrated in FIG. 6, when a table is used as a memory, an even number address and an odd number address may not be alternately read, differently from the case of a FIFO. Therefore, in the error detection device 10 illustrated in FIG. 6, a probability that an error is detected may be reduced depending on a storage position of data. In an error detection device 10 illustrated in FIG. 7, the number of parity bits is increased to 2 bits or more.

In the error detection device illustrated in FIG. 7, the same reference numeral is used for a configuration element that is substantially the same as or similar to that of the error detection device 10 illustrated in FIG. 6, and the detailed description may be omitted or reduced herein. For example, selectors 13b, 161b, and 162b of the error detection device 10 illustrated in FIG. 7 respectively correspond to the selectors 13a, 161a, and 162a illustrated in FIG. 6.

The data definition switching control unit 15 outputs a 2-bit portion on the LSB side of the write address, to the read data conversion unit 161, as a control signal. The write data conversion unit 13 performs switching of the definition of parity into four types, based on the control signal that has been input to the data definition switching control unit 15. For example, the write data conversion unit 13 divides parity bits into two groups. For example, the write data conversion unit 13 sets “odd number+odd number” parity as the parity definition when the control signal is “00”, and sets “odd number+even number” parity as the parity definition when the control signal is “01”. For example, the write data conversion unit 13 sets “even number+odd number” parity as the parity definition when the control signal is “10”, and sets “even number+even number” parity as the parity definition when the control signal is “11”.

Similarly, the data definition switching control unit 18 outputs a two bit-portion on the LSB side of the read address, to the read data conversion unit 162, as a control signal. The read data conversion unit 162 performs switching of the definition of parity into four types, based the control signal that has been input from the data definition switching control unit 18. For example, the read data conversion unit 162 sets “odd number+odd number” parity as the parity definition when the control signal is “00”, sets “odd number+even number” parity as the parity definition when the control signal is “01”, sets “even number+odd number” parity as the parity definition when the control signal is “10”, and sets “even number+even number” parity as the parity definition when the control signal is “11”.

In the error detection device 10 illustrated in FIG. 7, the number of types of the parity definition is increased. Therefore, even when a table in which an even number address and an odd number address may not be alternately read is used as a memory, a probability that an error is detected may be increased.

The number of parity bits may not be 2 bits. The number of parity bits may be 3 bits or more that are within a range in which the circuit scale of the error detection device 10 is not excessively increased. In the error detection device 10, a reduction in an error detection probability caused by the usage of the table may be further decreased.

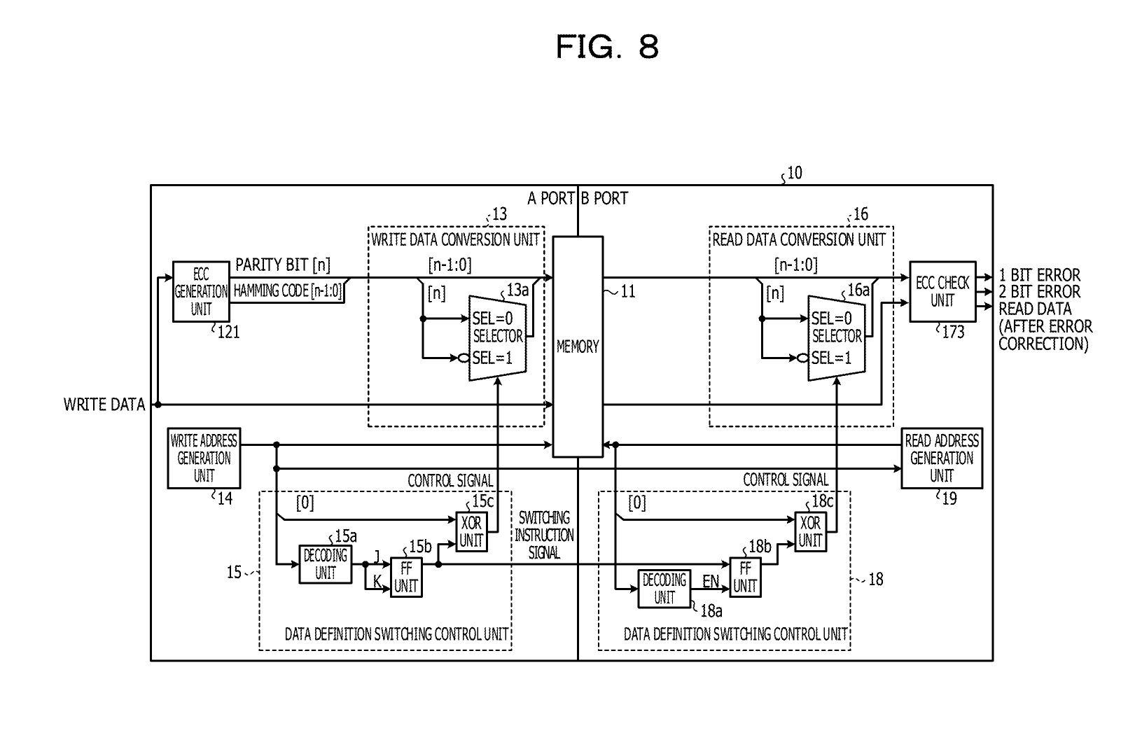

FIG. 8 illustrates an example of an error detection device. In an error detection device illustrated in FIG. 8, a FIFO is used as a memory, and the error determination code is different. Parity is not used as the error determination code, and a hamming code and a parity bit are used as an error check and correct (ECC) code.

In the error detection device illustrated in FIG. 8, the same reference numeral is used for a configuration element that is substantially the same as or similar to the error detection device 10 illustrated in FIG. 2, and the detailed description may be omitted herein. For example, an ECC generation unit 121 of the error detection device 10 illustrated in FIG. 8 may correspond to the error determination code generation unit 12 illustrated in FIG. 2, and an ECC check unit 173 may correspond to the error determination code check unit 17 illustrated in FIG. 2.

When the write address value reaches a full count value, the data definition switching control unit 15 inverts a switching instruction signal, and outputs exclusive OR between the inverted switching instruction signal and the LSB of the write address, to the write data conversion unit 13, as a control signal. The write data conversion unit 13 switches the definition of an ECC code when the control signal has been input from the data definition switching control unit 15. For example, in a case in which the control signal is “0”, the write data conversion unit 13 maintains the ECC code when the address of the write destination is an even number address, and inverts the parity bit of the ECC code when the address of the write destination is an odd number address. In a case in which the control signal is “1”, the write data conversion unit 13 inverts the parity bit of the ECC code when the address of the write destination is an even number address, and maintains the ECC code when the address of the write destination is an odd number address.

Similarly, when the read address value reaches a full count value, the data definition switching control unit 18 performs input of a switching instruction signal from the data definition switching control unit 15, and outputs exclusive OR between the switching instruction signal and the LSB of the read address, to the read data conversion unit 16, as a control signal. The read data conversion unit 16 switches the definition of an ECC code when the control signal has been input from the data definition switching control unit 18. For example, in a case in which the control signal is “0”, the read data conversion unit 16 maintains the ECC code when the address of the read source is an even number address, and inverts the parity bit of the ECC code when the address of the read source is an odd number address. In a case in which the control signal is “1”, the read data conversion unit 16 inverts the parity bit of the ECC code when the address of the read source is an even number address, and maintains the ECC code when the address of the read source is an odd number address.

Even when the error determination code is an ECC code, at the time of occurrence of a memory failure, the error detection device 10 illustrated in FIG. 8 detects an error (ECC 1 bit error), and performs notification of the error.

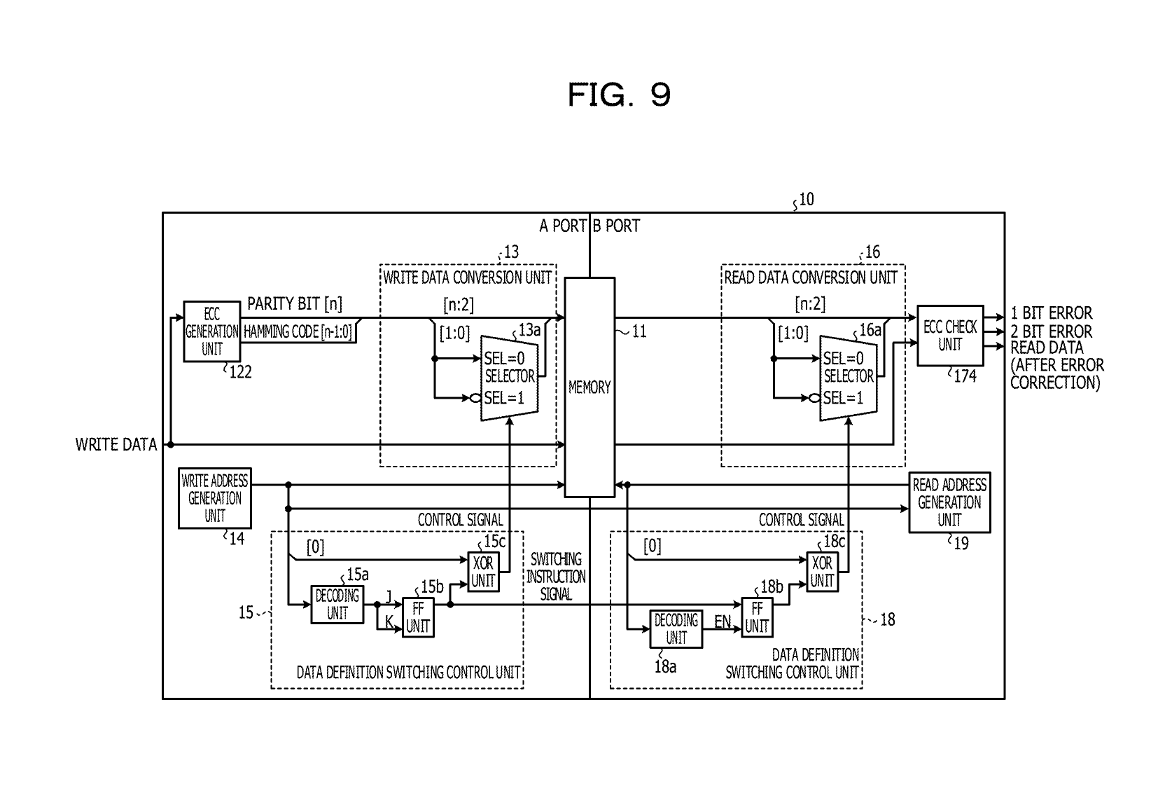

FIG. 9 illustrates an example of an error detection device. In an error detection device illustrated in FIG. 8, a FIFO is used as a memory, and an ECC code is used as an error determination code, and the number of bits of the hamming code of the ECC code is different from that of the error detection device illustrated in FIG. 8. For example, in the error detection device illustrated in FIG. 8, the parity bit is inverted, and an ECC 1 bit error is detected. In the error detection device illustrated in FIG. 9, the lower 2 bits of the hamming code are inverted, and an ECC 2 bit-error is detected.

In the error detection device illustrated in FIG. 9, the same reference numeral is used for a configuration element that is substantially the same as or similar to that of the error detection device 10 illustrated in FIG. 8, and the detailed description may be omitted or reduced herein. For example, an ECC generation unit 122 of the error detection device 10 illustrated in FIG. 9 may correspond to the ECC generation unit 121 illustrated in FIG. 8, and an ECC check unit 174 may correspond to the ECC check unit 173 illustrated in FIG. 8.

When the write address value reaches a full count value, the data definition switching control unit 15 inverts a switching instruction signal, and outputs exclusive OR between the inverted switching instruction signal and the LSB of the write address, to the write data conversion unit 13, as a control signal. The write data conversion unit 13 switches the definition of an ECC code when the control signal has been input from the data definition switching control unit 15. For example, in a case in which the control signal is “0”, the write data conversion unit 13 maintains the ECC code when the address of the write destination is an even number address, and inverts the lower 2 bits of the hamming code of the ECC code when the address of the write destination is an odd number address. In a case in which the control signal is “1”, the write data conversion unit 13 inverts the lower 2 bits of the hamming code of the ECC code when the address of the write destination is an even number address, and maintains the ECC code when the address of the write destination is an odd number address.

Similarly, when the read address value reaches a full count value, the data definition switching control unit 18 performs input of a switching instruction signal from the data definition switching control unit 15, and output exclusive OR between the switching instruction signal and the LSB of the read address, to the read data conversion unit 16, as a control signal. The read data conversion unit 16 switches the definition of an ECC code when the control signal has been input from the data definition switching control unit 18. For example, in a case in which the control signal is “0”, the read data conversion unit 16 maintains the ECC code when the address of the read source is an even number address, and inverts the lower 2 bits of the hamming code of the ECC code when the address of the read source is an odd number address. In a case in which the control signal is “1”, the read data conversion unit 16 inverts the lower 2 bits of the hamming code of the ECC code when the address of the read source is an even number address, and maintains the ECC code when the address of the read source is an odd number address.

In the error detection device 10 illustrated in FIG. 9, even when the error determination code is the ECC code, at the time of occurrence of a memory failure, an error (ECC 2 bit error) may be detected, and notification of the error may be performed.

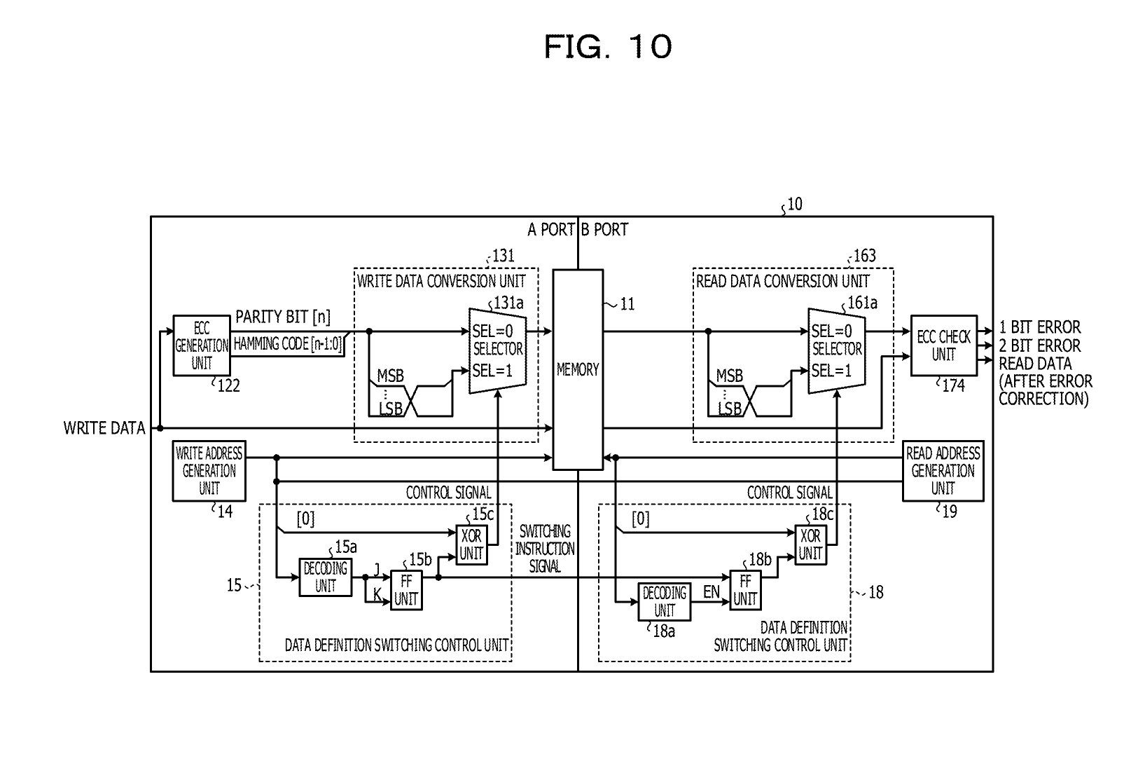

FIG. 10 illustrates an example of an error detection device. In an error detection device illustrated in FIG. 10, a FIFO is used as a memory, an ECC code is used as an error determination code, and a switching method of an ECC code used to perform error detection may be different. For example, in the error detection device illustrated in FIG. 9, the definition of the ECC code is switched, and for example, the lower 2 bits of the hamming code are inverted, and an ECC 2-bit error is detected. In the error detection device illustrated in FIG. 10, the sequence of the ECC code is changed, and an error is detected.

In the error detection device illustrated in FIG. 10, the same reference numeral is used for a configuration element that is substantially the same as or similar to that of the error detection device 10 illustrated in FIG. 9, and the detailed description may be omitted or reduced herein. For example, a write data conversion unit 131 of the error detection device 10 illustrated in FIG. 10 may correspond to the write data conversion unit 13 illustrated in FIG. 9, and a read data conversion unit 163 may correspond to the read data conversion unit 16 illustrated in FIG. 9.

When the write address value reaches a full count value, the data definition switching control unit 15 inverts a switching instruction signal, and outputs exclusive OR between the inverted switching instruction signal and the LSB of the write address, to the write data conversion unit 131, as a control signal. The write data conversion unit 131 changes the sequence of the ECC code when the control signal has been input from the data definition switching control unit 15. For example, in a case in which the control signal is “0”, the write data conversion unit 131 maintains the ECC code when the address of the write destination is an even number address, and rearranges the bits of the ECC code so as to change the sequence from the most significant bit (MSB) to the LSB of the ECC code into the sequence from the LSB of the ECC code to the most significant bit (MSB) of the ECC code when the address of the write destination is an odd number address. In a case in which the control signal is “1”, the write data conversion unit 131 rearranges the bits of the ECC code so as to change the sequence from the MSB of the ECC code to the LSB of the ECC code into the sequence from the LSB of the ECC code to the most significant bit (MSB) of the ECC code when the address of the write destination is an even number address, and maintains the ECC code when the address of the write destination is an odd number address.

Similarly, when the read address value reaches a full count value, the data definition switching control unit 18 performs input of a switching instruction signal from the data definition switching control unit 15, and outputs exclusive OR between the switching instruction signal and the LSB of the read address, to the read data conversion unit 163, as a control signal. The read data conversion unit 163 changes the sequence of the ECC code when the control signal has been input from the data definition switching control unit 18. For example, in a case in which the control signal is “0”, the read data conversion unit 163 maintains the ECC code when the address of the read source is an even number address, and rearranges the bits of the ECC code so as to change the sequence from the most significant bit (MSB) to the LSB of the ECC code into the sequence from the LSB of the ECC code to the most significant bit (MSB) of the ECC code when the address of the read source is an odd number address. In a case in which the control signal is “1”, the read data conversion unit 163 rearranges the bits of the ECC code so as to change the sequence from the most significant bit (MSB) to the LSB of the ECC code into the sequence from the LSB of the ECC code to the most significant bit (MSB) of the ECC code when the address of the read source is an even number address, and maintains the ECC code when the address of the read source is an odd number address.

In the error detection device 10 illustrated in FIG. 10, even when the error determination code is an ECC code, at the time of occurrence of a memory failure, an error, for example, an ECC 1-bit error or an ECC 2-bit error may be detected, and the notification of the error may be performed.

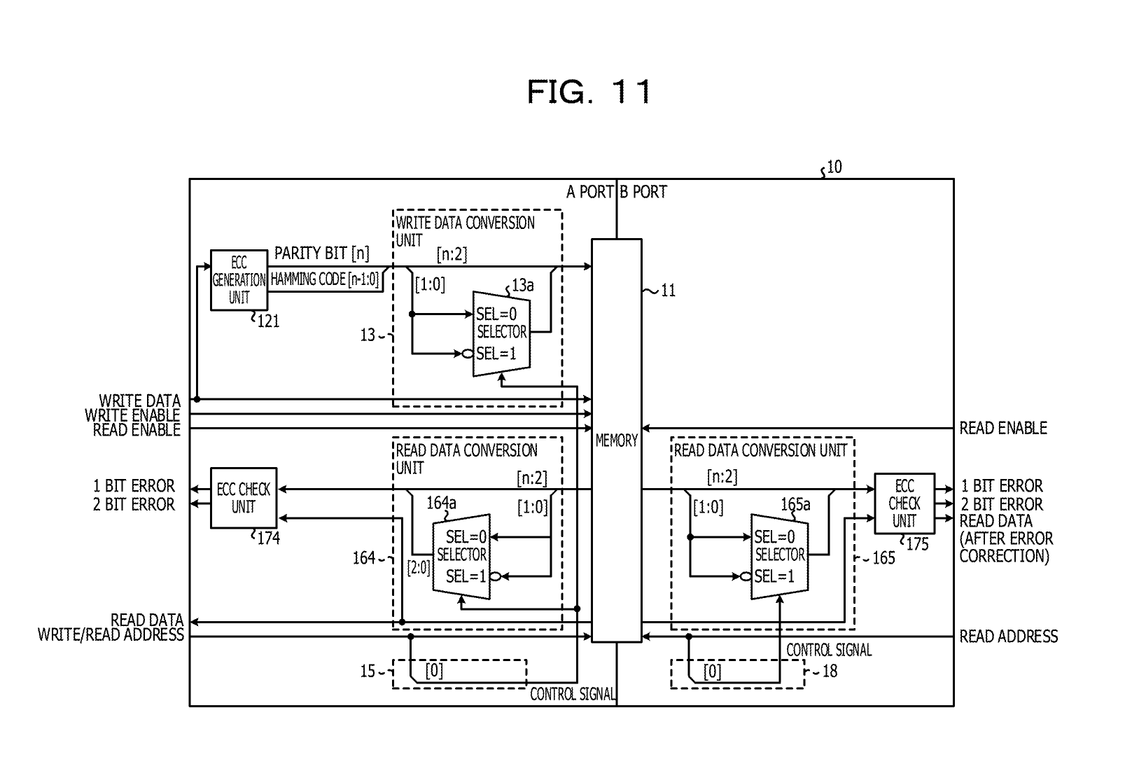

FIG. 11 illustrates an example of an error detection device. In an error detection device illustrated in FIG. 11, an ECC code is used as an error determination code, and a usage method of a memory may be different. In the error detection device illustrated in FIG. 11, a table is used as the memory.

In the error detection device illustrated in FIG. 11, the same reference numeral is used for a configuration element that is substantially the same as or similar to that of the error detection device 10 illustrated in FIG. 9, and the detailed description may be omitted or reduced herein. For example, read data conversion units 164 and 165 of the error detection device 10 illustrated in FIG. 11 may correspond to the read data conversion unit 16 illustrated in FIG. 9, and the ECC check units 174 and 175 may correspond to the ECC check unit 174 illustrated in FIG. 9.

The data definition switching control unit 15 outputs the LSB of the write address, to the read data conversion unit 164, as a control signal. The write data conversion unit 13 maintains or inverts the definition of an ECC error, based on the control signal that has been input from the data definition switching control unit 15. For example, the write data conversion unit 13 maintains the ECC code when the control signal is “0”, and inverts the lower 2 bits of the hamming code of the ECC code when the control signal is “1”.

Similarly, the data definition switching control unit 18 outputs the LSB of the read address, to the read data conversion unit 165, as a control signal. The read data conversion unit 165 maintains or inverts the definition of an ECC code, based on the control signal that has been input from the data definition switching control unit 18. For example, the read data conversion unit 165 maintains the ECC code when the control signal is “0”, and inverts the lower 2 bits of the hamming code of the ECC code when the control signal is “1”.

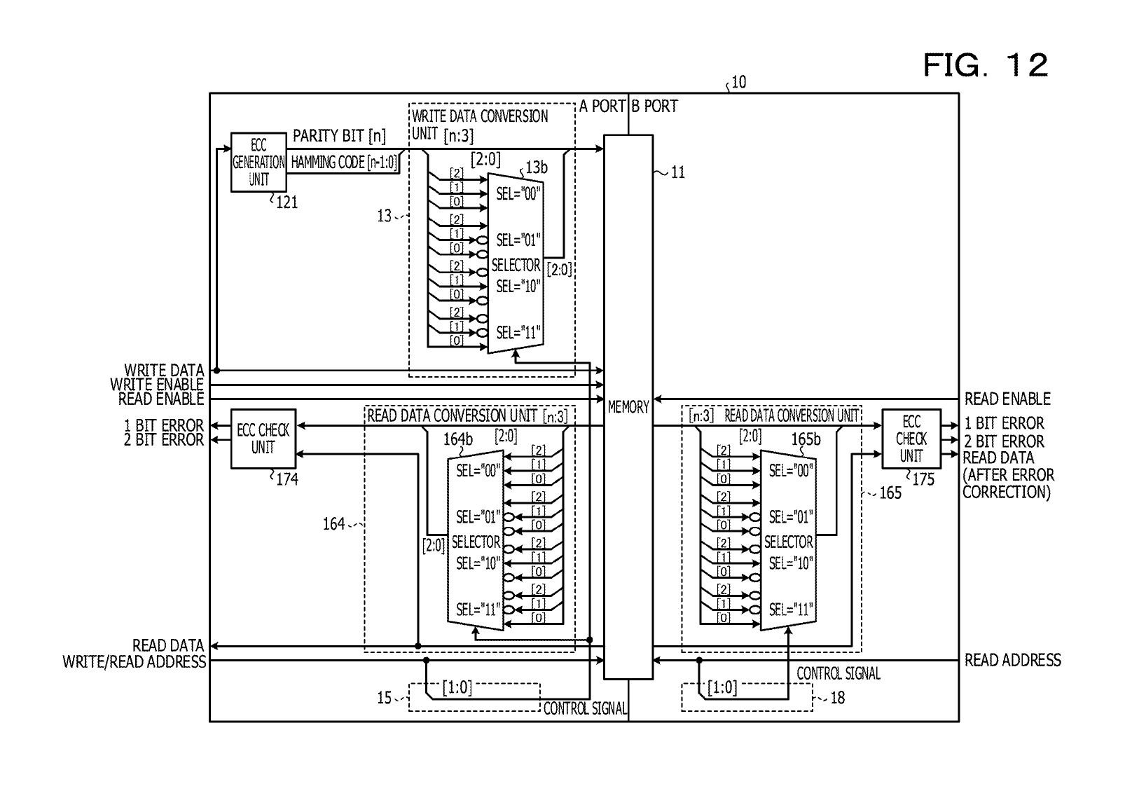

In the error detection device 10 illustrated in FIG. 11, data writing is performed using software, so that writing may not performed using something other than software. The failure in which writing is not performed is recognized by reading determination at the time of writing, so that measures may not be taken. In the error detection device 10 illustrated in FIG. 12, even when a failure occurs in the memory 11 due to damage of a circuit, or the like, an error may be detected by another simple configuration. In the error detection device 10 illustrated in FIG. 12, even when the error determination code is an ECC code, at the time of occurrence of a memory failure, an error, for example, an ECC 2-bit error may be detected, and notification of the error may be performed.

FIG. 12 illustrates an example of an error detection device. When a table is used as a memory, differently from a case of using FIFO as a memory, the consecutive addresses may not be read in order. Therefore, in the error detection device 10 illustrated in FIG. 11, a probability that an error is detected may be reduced depending on a storage position of data. In the error detection device 10 illustrated in FIG. 12, the number of lower bits of the hamming code of the ECC code is increased to 3 bits or more.

In the error detection device illustrated in FIG. 12, the same reference numeral is used for a configuration element that is substantially the same as or similar to that of the error detection device 10 illustrated in FIG. 11, and the detailed description may be omitted or reduced herein. For example, selectors 13b, 164b, and 165b of the error detection device 10 illustrated in FIG. 12 may correspond to the selectors 13a, 164a, and 165a of the error detection device 10 illustrated in FIG. 11, respectively.

The data definition switching control unit 15 outputs a 2 bit portion of the LSB on the write address side, to the read data conversion unit 164, as a control signal. The write data conversion unit 13 switches the definition of the ECC based on the control signal that has been input from the data definition switching control unit 15. For example, when the control signal is “00”, the write data conversion unit 13 maintains [2], [1], and [0] that are the lower 3 bits of the hamming code of the ECC code. When the control signal is “01”, the write data conversion unit 13 inverts the lower 2 bits ([1] and [0]) from among the lower 3 bits of the hamming code. When the control signal is “10”, the write data conversion unit 13 inverts the 2 bits ([2] and [0]) from among the lower 3 bits of the hamming code. When the control signal is “11”, the write data conversion unit 13 inverts the upper 2 bits ([2] and [1]), from among the lower 3 bits of the hamming code.

In the error detection device 10 illustrated in FIG. 12, even when the table in which the consecutive addresses may not be read in order is used as a memory, a probability that an error (ECC 2 bits error) is detected may be increased.

In the error detection device 10 illustrated in FIGS. 6 and 7, like as the odd number parity and the even number parity, the parity bit is an inversion target, but even when write data is the inversion target, a similar effect may be obtained. Similarly, in the error detection device 10 illustrated in FIGS. 8 to 12, like as the odd number parity and the even number parity, the ECC code is an inversion target, but even when write data is the inversion target, a similar effect may be obtained.

A protocol data unit (PDU) may be a packet, and may be a frame, a cell of an asynchronous transfer mode (ATM), or the like, for example, depending on a network type.

All or some of the configuration elements of the error detection device 10 may be divided or combined functionally or physically in a certain unit in accordance with various load, usage, and the like. For example, the error determination code generation unit 12 and the write data conversion unit 13, or the data definition switching control unit 18 and the read address generation unit 19 are combined with each other as a single configuration element. The data definition switching control unit 15 may be divided into a portion that performs output of exclusive OR between an inverted switching instruction signal and the LSB of a write address and a portion that performs control so that a control signal is switched for each write address. The memory 11 may be coupled to the error detection device 10 through a network or a cable, as an external device of the error detection device 10.

The error detection device 10 may include the above-described configuration elements together. For example, the technology illustrated in FIG. 10 by which the ECC code is rearranged may also be applied to the error detection device 10 illustrated in FIGS. 8, 11, and 13. The technology for improving ECC illustrated in FIG. 12 may also be applied to the error detection device 10 illustrated in FIGS. 8 to 11. A single error detection device may include the above-described plurality of configuration elements together within a range in which the functions of the configuration elements are not inhibited by each other. The ECC code may a hamming code and parity, and may be another code used to execute processing in a unit of an address.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An error detection device comprising:
a writing portion configured to write, in an address of the storage, first data including a first error determination code in which a different error detection rule is applied in association with the address;
a reading portion configured to read the first data from the storage as second data; and
a detector configures to detect an error, using a second error determination code of the second data.

2. The error detection device according to claim 1, wherein
the detector compares the first error determination code of the first data with the second error determination code of the second data, and detects the error based on the comparison result.

3. The error detection device according to claim 1, wherein
the write portion adds an odd number parity to the first data when the address is an even number address, and adds an even number parity to the first data when the address is an odd number address.

4. The error detection device according to claim 3, wherein
the detector detects the error by applying a first error detection rule corresponding to the odd number parity to the second data read from the even number address, and detects the error by applying a second detection rule corresponding to the even number parity to the second data read from the odd number address.

5. The error detection device according to claim 1, wherein
the error determination code is parity, and
the storage includes a table in which the first data to which the parity is added is written using software.

6. The error detection device according to claim 1, wherein
the write portion adds a first error check and correct (ECC) code to the first data when the address is an even number address, and adds a second ECC code obtained by inverting a parity bit of the first ECC code, to the first data when the address is an odd number address.

7. The error detection device according to claim 1, wherein
the write portion adds a first error check and correct (ECC) code to the first data when the address is an even number address, and adds a second ECC code obtained by inverting lower 2 bits of a hamming code of the first ECC code, to the first data when the address is an odd number address.

8. The error detection device according to claim 1, wherein
the write portion adds a first error check and correct (ECC) code to the first data when the address is an even number address, and adds a second ECC code obtained by rearranging a bit sequence of the first ECC code from in an order from a most significant bit (MSB) to a least significant bit (LSB) into in an order from the least significant bit (LSB) to the most significant bit (MSB), to the first data when the address is an odd number address.

9. The error detection device according to claim 1, wherein
the error determination code is an error check and correct (ECC) code, and
the storage includes a table in which the data to which the ECC code is added is written using software.

10. The error detection device according to claim 9, wherein
the error determination code is an ECC code in which a number of lower bits of a hamming code is 3 bits or more.

11. The error detection device according to claim 5, wherein
the parity has 2 bits or more.

12. The error detection device according to claim 1, wherein
the first data is packet data received from outside of the error detection device, and transmitted to the outside of the error detection device.

13. An error detection method comprising:
adding, to first data, a first error determination code to which a different error detection rule is applied in associated with an address in a storage, writing the first data to the address by an error detection device;
reading the first data from the storage as second data by the error detection device; and
detecting an error, using a second error determination code of the second data by the error detection device.

14. The error detection method according to claim 13, further comprising:
comparing the first error determination code of the first data with the second error determination code of the second data; and
detecting the error based on the comparison result.

15. The error detection method according to claim 13, further comprising:
adding an odd number parity to the first data when the address is an even number address; and
adding an even number parity to the first data when the address is an odd number address.

16. The error detection method according to claim 15, further comprising:
applying a first error detection rule corresponding to the odd number parity to the second data read from the even number address; and
applying a second detection rule corresponding to the even number parity to the second data read from the odd number address.

17. The error detection method according to claim 13, wherein
the error determination code is parity, and
the storage includes a table in which the first data to which the parity is added is written using software.

18. The error detection method according to claim 13, further comprising;
adding a first error check and correct (ECC) code to the first data when the address is an even number address; and
adding a second ECC code obtained by inverting a parity bit of the first ECC code to the first data when the address is an odd number address.

19. The error detection method according to claim 13, further comprising;
adding a first error check and correct (ECC) code to the first data when the address is an even number address; and
adding a second ECC code obtained by inverting lower 2 bits of a hamming code of the first ECC code to the first data when the address is an odd number address.

20. The error detection method according to claim 13, further comprising:
adding a first error check and correct (ECC) code to the first data when the address is an even number address; and
adding a second ECC code obtained by rearranging a bit sequence of the first ECC code from in an order from a most significant bit (MSB) to a least significant bit (LSB) into in an order from the least significant bit (LSB) to the most significant bit (MSB) to the first data when the address is an odd number address.
